(19) United States
(12) Patent Application Publication
(10) Pub. No.: US 2011/0121797 A1
(43) Pub. Date: May 26, 2011

(54) DELAY COMPENSATION FOR A DC-DC CONVERTER

(75) Inventor: Bobby Jacob Daniel, Eindhoven (NL)

(73) Assignee: NXP B.V., Eindhoven (NL)

(21) Appl. No.: 13/055,840

(22) PCT Filed: Jul. 28, 2009
(86) PCT No.: PCT/IB2009/053275

§ 371 Date: Jan. 25, 2011

(30) Foreign Application Priority Data
Jul. 28, 2008 (EP) 08104896.9

(51) Int. Cl. G05F 1/46

(52) U.S. Cl. 323/265

(57) ABSTRACT

A method of controlling a DC-DC converter is disclosed, which provides for compensation of the loop-delay caused by, for instance, delays in operation of the comparator. The method is exemplified with reference to, but not limited to, a hysteretic converter.

### FIELD OF THE INVENTION

This invention relates to power supplies and in particular to DC-DC converters for use in power supplies.

### BACKGROUND OF THE INVENTION

Much electrical equipment, and in particular the majority of modern electronic equipment, operates from a direct current (DC) power supply. However, at least as far as permanent electrical supplies are concerned, the vast majority of fixed power for use by at least domestic users is in the form of an alternating current (AC) supply which is delivered to the household or home at a nominal voltage, which, depending on geographical location, is typically at 110V, 220V, 240V. Thus there is a large demand for electrical power converters which can convert from an AC mains supply to a DC form of electrical power.

Moreover, for electrical or electronic equipment which is powered from a DC supply, it is becoming increasingly more frequent that the equipment utilises the variety of DC voltage levels. Thus, a personal computer may have a DC power supply at 24V, and yet include some systems or components which operate at 24V, 12v, or 5V. As further examples, personal mobile equipment such as PDAs or mobile telephones may operate from a battery supplying a fixed voltage of 4.8V, and yet include circuitry or integrated circuits (IC) which operates from different voltages such as 1.7V or 3.3V. A example personal computer chip Greenchip™, available from NXP Semiconductors, supplies each of 12V, 5V and 3.3V. Mobile Flash typically require between 3.5V to 4V. Hysteretic buck converter LED driver ICs such as the Coala TM chip also from NXP Semiconductors provides outputs ranging from 6V to 22V, from a 24V design input.

In order to deliver DC voltages which are different from the supplied DC voltage, DC-DC converters are commonly used.

An example of a DC-DC converter is the hysteretic converter. A hysteretic DC-DC converter typically has an input which is switchably connected to an inductor. The other side of the inductor may be connected to a capacitor and provides a regulated DC output. Using a pair of transistors or other switches, the input to the inductor is switched between the nominal supply voltage and nominal ground. The current through the inductor thus alternately increases and decreases. The average voltage at the output thus depends, to a first approximation, on the mark-space ratio of the input voltage: at one extreme, if the input voltage is always at nominal supply, the output voltage will also be at nominal supply; at the opposite extreme, if the input voltage is always at nominal ground, the output voltage will also be at nominal ground. For a typical mark-space ratio where the input to the inductor is high for 50% of the cycle time, the output voltage will be nominally 50% of the supply voltage. In general, for a buck converter, the output voltage (Vout) is equal to the input voltage (vVn), scaled by the dutycycle:

Vout=Vin·Dutycycle

In such a hysteretic converter, the current through the inductor typically has a saw-tooth profile. The current increases from a desired minimum or valley level, linearly, until it reaches a desired maximum or peak level. Once it reaches this maximum desired level, the input is switched to low, and the current falls, again linearly, from the peak level to the desired valley level. Once the current reaches the desired valley level, the input is again switched, this time to the high or supply voltage, and the current in the inductor starts to rise again. Thus the current has an approximately saw-tooth profile. The profile is typically not symmetrical: that is to say the current typically will rise at a different rate from that at which it falls.

In a practical device, this current cycle or current loop normally does not follow the idealised saw-tooth described above. One particular delay in the loop, or loop-delay, which causes inaccuracies, is the delay attributable to the comparator: in order to determine when to switch the input voltage, the inductor current is sensed (usually by means of a voltage across a sensing resistor); this voltage is compared to a reference level by means of a comparator; however, because of the time taken by the comparator to establish the comparison, the input voltage is not switched until a moment somewhat after the current passes the reference level. Thus, because of this delay, there is a current overshoot and/or undershoot beyond the intended peak or valley level.

In a hysteretic converter, the average current will be midway between the peak and valley levels. The expected average current will be midway between the internally set reference peak and valley levels. However, if there is a delay, Td, from the moment of the current crossing the reference level to the moment when the converter switches the other way, this will result in a current overshoot which is equal to Td×dI/dt_rise, where I is current through the inductor, the dI/dt is the rate of change of current, and dI/dt_rise refers to the current slope during the rise period. An equivalent undershoot would equal Td×dI/dt_fall.

This results in the following two effects: firstly, the ripple, which may be defined as the variation between the maximum and minimum current through the inductor, will be more than that intended, by the sum of the overshoots; secondly, if the rising and falling slopes, dI/dt_rise and dI/dt_fall, are different, which is usually the case, there will be a deviation between the actual average current, and the intended average current (which is the mean of the reference peak and valley levels).

US patent application publication US 2007/0103126 discloses a method to compensate for the DC offset attributable to the mismatch between undershoot and overshoot. Based on a measured overshoot, the fall period of the inductor current is extended such that the current falls below the reference value level. Since the current fall rate is generally lower than the current rise rate, the loop delay at the valley would normally result in less undershoot than the overshoot which is experienced at the peak. However, the undershoot period is deliberately extended in time such that the undershoot current is equivalent to the overshoot current: the effects therefore cancel out and the average current resulting is the mean of the reference peak and valley levels. Thus, this prior art compensates for the average current offset, but in fact increases the output ripple. Moreover, the method is calculation intensive and does not take into account variation in the loop delay Td due to process, voltage and temperature changes. These variations can be significant.

There thus remains an ongoing requirement for methods to compensate for the loop delay in DC-DC converters.

### SUMMARY OF THE INVENTION

It is an object of the present invention to provide an improved method for compensating for loop delay in DC-DC converters.

According to the invention there is provided a method of controlling a DC-DC converter having a first state and a second state each of which is either a charging state or a discharging state, the DC-DC converter being arranged to change state from the first state to the second state in dependence on a predetermined limit value of a signal, and having a delay between a change instruction and a change of state from the first state to the second state, the method comprising the steps of:
(a) determining a rate signal indicative of the rate of change of the signal whilst the DC-DC converter is in the first state,
(b) determining a delay signal indicative of the delay,
(c) determining an overshoot in dependence on the rate signal and the delay signal, and
(d) offsetting the predetermined limit value by an amount which corresponds to the overshoot.
   Advantageously, the first state is the charging state and the second state is the discharging state. Alternatively, the first state is the discharging state and the second state is the charging state. Thus the invention relates to each, or both, of the transitions from charging to discharging, and from discharging to charging.

Preferably the signal is a voltage, since this provides a particularly convenient signal to measure and manipulate.

Typically the overshoot is equal to the rate of change of voltage multiplied by the delay.

Beneficially, step (a) may comprise applying a copy of the voltage across a first capacitor to produce a resulting current, and step (c) may comprise charging a second capacitor with a mirror of the resulting current. These represent particularly convenient implementations of the above steps, which are easily and inexpensively put into practice using it analogue components. Alternatively these steps may be carried out through digital processing.

Advantageously, the overshoot may be determined in step (c) by means of determining the voltage across the second capacitor, at the end of a charging period corresponding to the delay signal.

The above advantageous but not limiting aspects of the invention are equally applicable to the transition between the discharging and charging state, mutatis mutandis.

Advantageously, the invention encompasses controlling the DC-DC converter during the charging-to-discharging transition as described above, and subsequently controlling the DC-DC converter from the discharging-to-charging transition as described above. Thus the invention encompasses full control of the inverter at both ends of the current loop.

In a particularly convenient implementation, the DC-DC converter is operable under hysteretic control. Alternatively or additionally the DC-DC converter may be operable under peak current control and/or valley current control.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 is a schematic of a hysteretic converter with loop delay compensation according to an aspect of the present invention;

FIG. 2 shows the variation of output current for a hysteretic converter according to the prior art;

FIG. 3 shows the variation of output current, and peak and valley reference levels, over time, for a hysteretic converter operated according to an embodiment of the invention;

FIG. 4 shows wave forms of various nodes in the schematic of FIG. 1.

FIG. 5 is a circuit diagram implementing a peak loop delay;

FIG. 6 shows waveforms corresponding to the circuit of FIG. 5; and

FIG. 7 is a circuit diagram implementing a valley loop delay.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

### DETAILED DESCRIPTION OF EMBODIMENTS

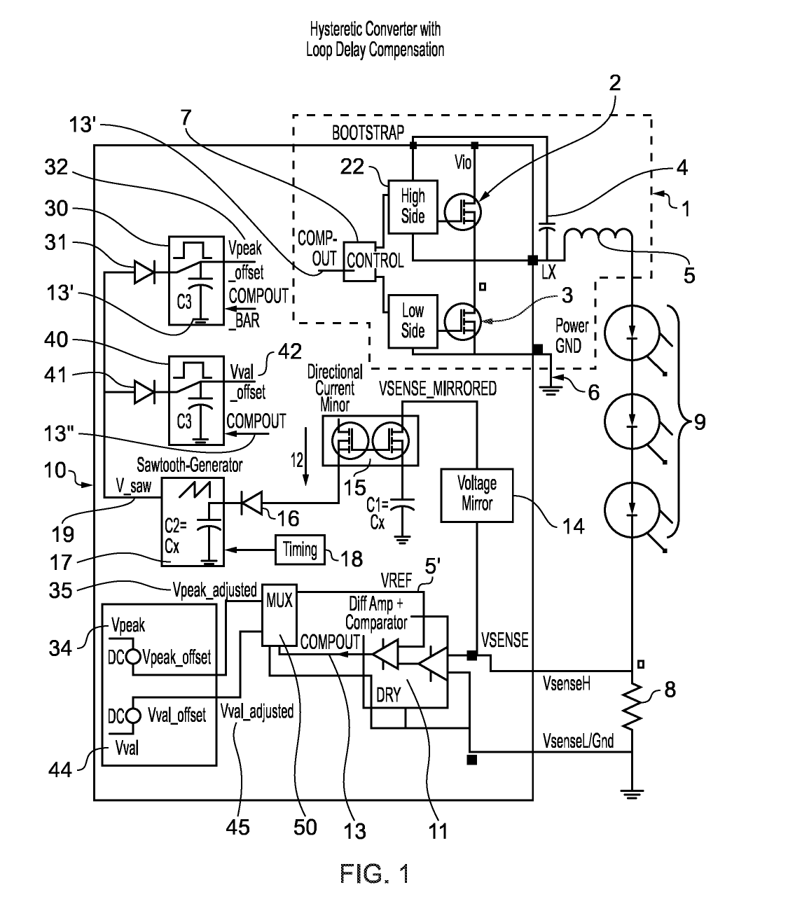

FIG. 1 shows a hysteretic converter with loop delay compensation. The basic converter shown in region 1 comprises high side switch 2 and low side switch 3 connected in series between supply voltage Vin and ground level 4. The midpoint node LX between high side switch 2 and low side switch 3 is connected to capacitor 4 and to one terminal of an inductor 5. High side switch 2 and low side switch 3 are driven by respective drivers 22 and 32; these are both controlled by controller 7.

The output current from the inductor 5 is sensed by means of senses resistor 8, which is connected between load 9 and ground.

In this particular example the load 9 is shown as a string of lights emitting diodes (LEDs); however, the load is not limited to LEDs, and could be, for example, fluorescent lamps, battery which is being charged, PC circuitry, mobile device electronics and the like. In each case, the current sensing resistor has to be placed at the appropriate location to get the actual current: thus it may be located at the switch side of the inductor or between the switch and the supply, or between the switch and ground, as appropriate.

Within the control means 10, resides a differential amplifier and comparator 11.

As described up to this point, the hysteretic converter is the same as prior art hysteretic converters. In operation of such prior art converters, the current through the inductor, and load, is sensed by means of sense resistor 8. The voltage across the sense resistor 8 is input into the comparator and differential amplifier 11. This voltage is compared in the comparator 11 with a peak voltage (Vpeak)—not shown—for the peak comparison, and to a valley voltage (Vval)—not shown—of the respective valley comparison. The output from the comparator (shown at 13) is input to the control means 7 for driving the high side and low side switches 2 and 3 respectively.

In contrast, as shown in FIG. 1 this embodiment of the invention incorporates additional control functionality. The functional blocks will now be described, and this will be followed by a description of the operation of this embodiment. In particular, in addition to being input into the comparator and differential amplifier 11, the sense voltage is applied, by means of a voltage mirror or voltage buffer 14, to a directional current mirror 15. Directional current mirror 15 both charges first capacitor C1, and, by means of diode 16, saw-tooth generators 17. Saw-tooth generator 17 is controlled by means of timing block 18, and operates to repetitively charge capacitor C2, and provide a saw-tooth voltage output 19 (V-saw). Saw-tooth voltage 19 is connected by means diode 31 to peak offset generator 30. The saw-tooth output 19 is used to charge capacitor 3 in the offset generator 30, under control of the inverse 13′ of the comparator output 13. In addition the saw-tooth output 19 is input to a valley offset generator 40 by means of diode 41. In this control block, capacitor C3 is charged under control from the comparator output 13. The peak voltage offset 32 and the valley voltage offset 42 output from the offset generators 30 and 40 respectively, are applied to the predetermined peak voltage 34 and valley voltage 44, to result in adjusted peak voltage 35 and adjusted valley voltage 45 respectively. These are multiplexed via multiplex 50 and supplied as reference voltage 51 into the differential amplifier and comparator 11.

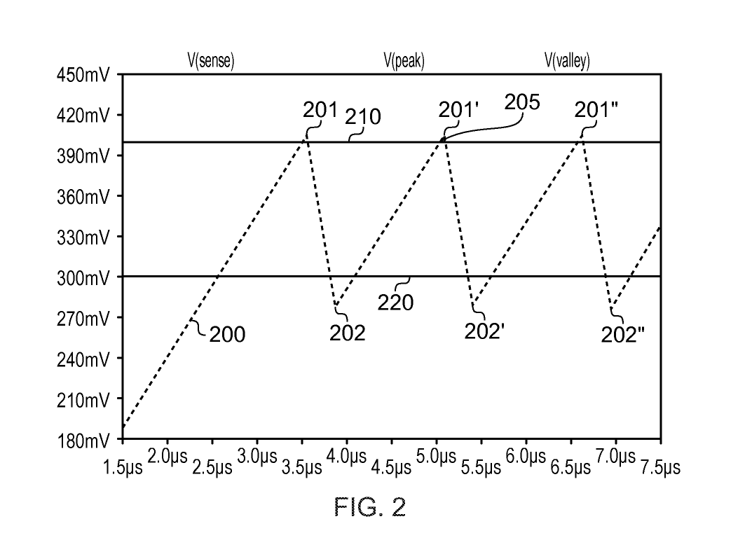

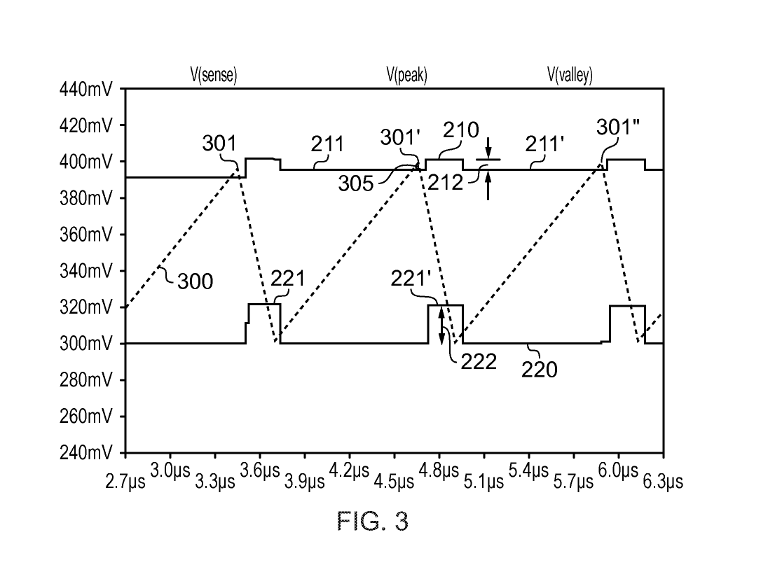

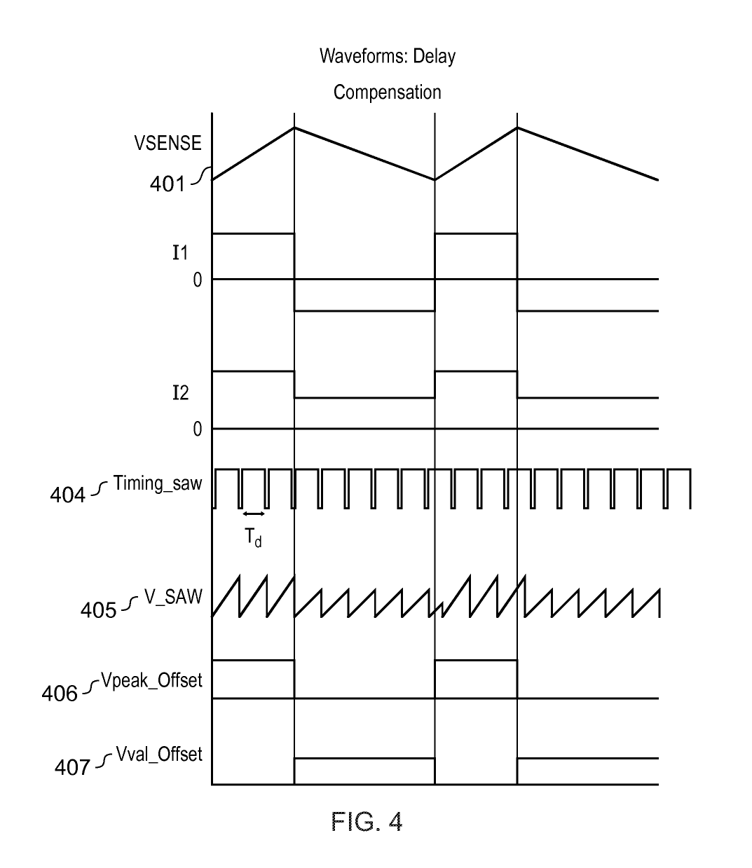

An overview of the operation of this embodiment of the invention will now be given with reference to FIGS. 2 and 3; this will be followed by a more detailed explanation of the implementation of this embodiment, as shown in FIG. 1, with reference to the wave forms of FIG. 4.

FIG. 2 shows the variation in time of the voltage across the sense resistor, which is indicative of the output current from the converter. After an initial ramp up period, the voltage 200 is shown to vary in a saw-tooth fashion, peaking at 201, 201′, and 201″, and with valleys at 202, 202′ and 202″. The predetermined peak level 210 is seen to be slightly below the value of the consecutive actual peaks 201, 201′ and 201″. Furthermore, the predetermined valley level 220 is somewhat above the actual valley shown at 202, 202′, and 202″. Since the difference between the predetermined valley and the actual valleys is larger than the difference between the predetermined peak 210 and the actual peaks 201, the mean value of the actual voltage (which corresponds to the midpoint between level 202 and 201), will be at a higher level than the average value calculated from the predetermined valley and peak (being the midpoint between levels 210 and 220): there thus exists a DC offset (negative in this case) between the expected average voltage (midpoint between 210 and 220) and the actual average voltage (midpoint between 202 and 201).

The operation of this embodiment of the invention may easily be understood with reference to FIG. 3. This figure shows the variation in time of the voltage across the sense resistor for a hysteretic converter operated in accordance with this embodiment of the invention. The sense voltage 32 has the same rise gradient as that shown in FIG. 2, and similarly has the same fall gradient. However, in this case the actual peaks 301, 301′ and 301″ of the sense voltage 300 are at the same value as the predetermined reference peak level 210. This is due to the fact that the reference peak 210 has been offset by level 212 which corresponds to the difference between the reference level 210 and the actual peak level 201 of a converter without compensation. Applying the offset 212 to the predetermined peak voltage 210 results in an adjusted peak voltage 211, 211′. It is this level 211, 211′ which is used by the comparator in order to determine the moment of switching.

A better understanding of this aspect of the embodiment may be obtained by comparison of FIG. 3 and FIG. 2. The shaded triangle 305 in FIG. 3 corresponds in area and shape to the shaded triangle 205 in FIG. 2. The height of the triangle 205 in FIG. 2 represents an overshoot of the sense voltage beyond the intended predetermined voltage peak; in contrast, however, the base of the triangle 305, which base is at the adjusted peak voltage 211, is depressed, relative to the peak voltage 210, by such an amount so that the apex of triangle 305, which apex 301′ represents the actual peak voltage, is at the same level as the predetermined peak voltage 210.

In this embodiment of the invention an analogous compensation method is applied, mutatis mutandis to the valley level of the sense voltage. That is to say, an undershoot rather than an overshoot is avoided, by increasing the predetermined valley level by an offset 222, to result in an adjusted valley level 221, 221′. The decision to switch the high side and low side switches, by the comparator, is taken at the moment the sense voltage 300 crosses the adjusted valley voltage 221. Because of the delay, however, the decision only takes effect at a later moment, at which time the sense voltage 300 has reached exactly the original predetermined valley level.

As shown in FIG. 3 the offset between the adjusted valley level 221, 221′ and original predetermined valley level 220, that is to say, offset 222, is larger that the equivalent offset 212 for the peak voltage. However, the method according to this embodiment of the invention is equally applicable if the offsets 222 and 212 are equal in magnitude, or if peak offset 212 is larger than valley offset 222.

Operation of this embodiment of the invention will now be described in more detail with reference to the wave forms of FIG. 4. Listed from the top of the figure, the waveforms in FIG. 4 are those of the sense voltage 401; input 11, and output 12 of the directional current mirror 15; timing saw-tooth 404, corresponding to the output of timing means 18; voltage saw-tooth 405 corresponding to the voltage saw-tooth output 19 of FIG. 1; offset to the peak voltage 406; and offset to the value voltage, 407.

I1 and I2 represent the current at the respective input and output of the directional current mirror 15 shown in FIG. 1: I1 represents the current flowing into capacitor C1, and is thus opposite in polarity in the two—charge and discharge—phases; 2 represent the current on the other side of the mirror—which has thus been rectified. As will be discussed further below, in some specific embodiments, which operate differently in the two phases, there is no single form I2 of the output from the current mirror, since there are two separate current mirrors.

In order to accurately and repeatedly compensate for the delay, it is important to be able to accurately and repeatedly calculate the required offset to the voltage peak and voltage valley 34 and 44 respectively. This is done in this embodiment by using the timing information of trace 404. The timing information accurately replicates the actual delay Td. A voltage saw-tooth 405 is then constructed using two input elements: the repetition rate of the saw-tooth is directly determined from the timing information 404; the gradient of the saw-tooth is determined from the gradient of the sense voltage. In the particular implementation shown in FIG. 1, the gradient of the sense voltage, that is to say the dVsense/dt, is computed by charging a first capacitor (C1) using a copy of Vsense and mirroring the current (C.dV/dt) which is then used to charge another capacitance of the same value. After exactly Td, the voltage on the second capacitance (C2) will be equal to Td×dVsense/dT. Then, the capacitance is quickly discharged, and again recharged for the duration of Td. Thus a saw-tooth is created, peaking at a value exactly equal to the compensation required. The required offset to the peak voltage, 406, is thus equivalent to the top level of the saw-tooth. The top of the saw-tooth is tapped by connecting the second capacitant C2 via a diode to a third, much smaller capacitor C3. C3 is used to store the peak of the saw-tooth, and is reset to zero during the next phase.

Once the switches have been switched and the current through the inductor, and thus sense voltage 401, is reducing, a new saw-tooth voltage is established, as shown at the second section of trace 405. The same timing information 404 is used such that the period Td of the saw-tooth is unchanged with respect to the first section of trace 405, however, the gradient of the saw-tooth now corresponds to the rate of fall of Vsense. Since in this instance Vsense falls more slowly than it had been rising, the gradient of the saw-tooth is lower than that in the first section. The peak value reached by the saw-tooth before being reset after period Td is thus lower than that in this first section. Thus in this example the offset to the valley voltage, 407, is smaller than the equivalent offset in the peak voltage, 406. (For clarity, and ease of understanding, it is noticed that this is the opposite relationship to that shown in the example of FIG. 3, wherein the offset to the valley voltage is greater than the offset to the peak voltage.)

Since at any one time the sense voltage 401 is either rising or falling, and not both, only one of offset 406 and 407 is required at any time, hence the same capacitor C3 can be used to store the offset information for both valley and peak.

The adjusted peak and valley voltages, 35 and 45 as shown on FIG. 1, are calculated according to this embodiment of the invention during each cycle and used as reference levels in the comparator. The embodiments thus automatically provide compensation irrespective of changes in conditions such as temperature, output voltage, and so on. Thus the solution to the problem provided by this embodiments of the invention is self aligning—the under and overshoots are always exactly compensated for since the gradient of the sense voltage, dVsense/dt, is used along with the actual delay information from a matched delay block.

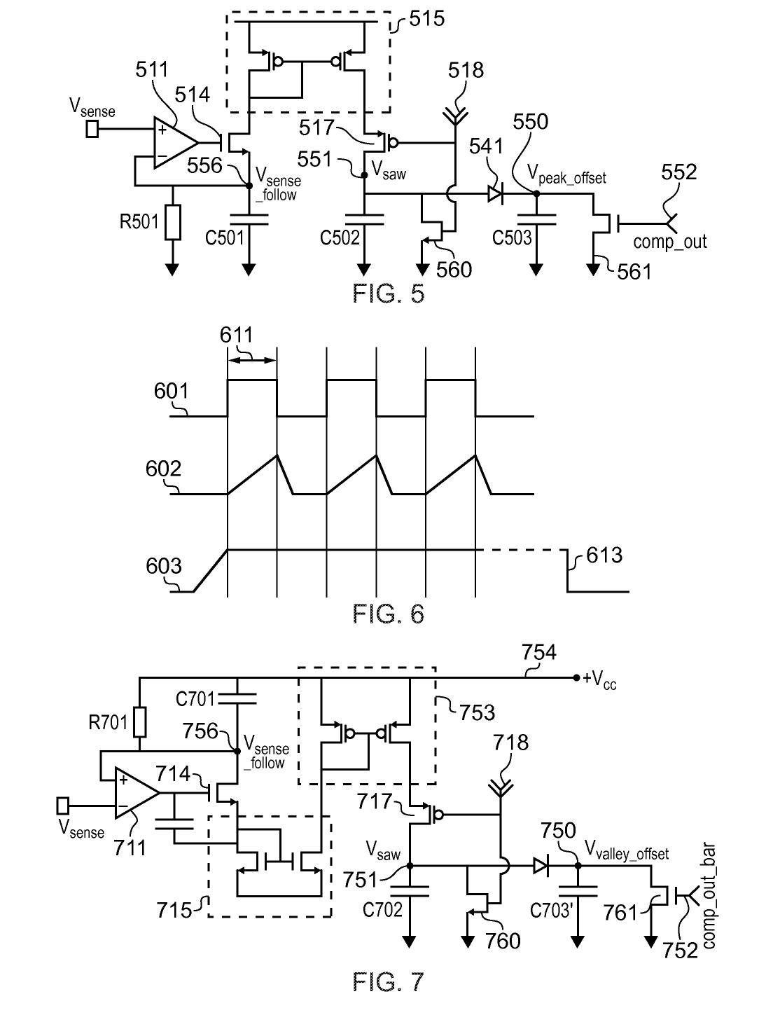

A circuit diagram according to a second embodiment of the invention is shown in FIGS. 5 and 7. FIG. 5 depicts a circuit to implement a peak offset, and FIG. 7 depicts a circuit which implements a valley offset. The circuit of FIG. 7 is similar to that of FIG. 5, and so similar reference numerals are used for similar components. Moreover, where these have a corresponding component or functional block in FIG. 1, similar reference numerals to those of FIG. 1 are used.

In FIG. 5, the sense voltage Vsense is applied to the positive input of a differential amplifier or operational amplifier (op-amp) 511; the negative input is connected to ground via a high value resistor R501. The output of the opamp is fed-back via source follower 514, to the negative terminal of the op-amp 511. This ensures that the negative terminal follows the voltage of the positive terminal; the output node 556 from the op-amp, is thus appropriately labelled vsense_follow. Capacitor C501 is connected between vsense_follow node 556 and ground, such that the voltage across capacitor C501 follows Vsense while Vsense is rising. The current required to charge C501 comes from high side current mirror 515, connected through the source of source follower 514. Resistor R501 is provided in order to ensure that the capacitor discharges when Vsense starts falling. It is desirable that this resistor have minimal effect while Vsense is rising, hence a high resistance is chosen for resistor R501.

The current mirror 515 mirrors the C501 charging current, through the source of transistor 517 which thus as a saw-tooth.

Thus, the drain of transistor 517, which corresponds to saw-tooth node Vsaw (551) is connected to ground via capacitor C502; the gate of transistor 517 is connected to the saw-tooth timing input 518. Saw-tooth timing node 518 is also connected as gate to a transistor 560 which is connected between the voltage saw-tooth node 551 and ground. Thus saw-tooth node 551 is the voltage across capacitor C502, and the saw-tooth is made by supplying the mirrored current for the exact duration as the T_delay. Thus input 508 is high for time T_delay, then low for some time, then high again for T_delay. During the low phase of 508, transistor 560 will discharge c502. This results in a saw-tooth, having alternate charging and discharging phases.

The voltage saw-tooth node 551 charges capacitor C503 via diode 541, to produce the Vpeak-offset, at node 550 (that is, at the high side of capacitor C503). The peak-offset node 550 is also connected to ground via reset transistor 561, the gate of which is connected to the comparator output comp_out.

Operationally, this circuit works as described above with regard to the schematic diagram of FIG. 1.

FIG. 7 depicts a circuit which implements a valley offset, and operates in a substantially similar manner to the circuit of FIG. 5. Thus in FIG. 7, the sense voltage Vsense is applied to the negative input of a differential amplifier or operational amplifier (op-amp) 711; the negative input is connected to the analog supply rail +Vcc via a high value resistor R701. The output of the opamp is fed-back via source follower 714, to the positve terminal of the op-amp 711. This ensures that the positive terminal follows the voltage of the negative terminal; the output node 756 from the op-amp is vsense_follow. Capacitor C701 is connected between vsense_follow node 756 and Vcc, such that the voltage across capacitor C701 follows Vsense while Vsense is rising. The current required to charge C701 comes from low side current mirror 715, connected through the source of source follower 714. Resistor R701 is provided in order to ensure that the capacitor discharges when Vsense starts falling. It is desirable that this resistor have minimal effect while Vsense is rising, hence a high resistance is chosen for resistor R701.

The current mirror 715 mirrors the C701 charging current, through the source of transistor 717 which thus as a saw-tooth.

The low side connection to the voltage buffer 714 is connected to current mirror 715, the output from which is connected only indirectly to the source of transistor 717 which is acting as a saw-tooth. That is, unlike the circuit of FIG. 5, wherein the output from the equivalent current mirror 515 is connected directly to the source of transistor 517, in this case, the output from current mirror 715 is connected to the transistor 717, by means of a second current mirror 753. This current mirror 753 comprises a pair of p-channel enhancement mode MOSFETs. In contrast, the current mirror 715 comprises n-channel MOSFETs; since in this circuit it is required to follow the dV/dt when Vsense is falling, the capacitor has to be connected to Vcc, and the current then needs to be first mirrored on the low side using NMOSTs.

The drain of transistor 717, which corresponds to saw-tooth node Vsaw (551) is connected to ground via capacitor C702; the gate of transistor 717 is connected to the saw-tooth timing input 718. Saw-tooth timing node 718 is also connected as gate to a transistor 760 which is connected between the voltage saw-tooth node 751 and ground. Thus saw-tooth node 751 is the voltage across capacitor C702, and the saw-tooth is made by supplying the mirrored current for the exact duration as the T_delay. Thus input 708 is high for time T_delay, then low for some time, then high again for T_delay. During the low phase of 708, transistor 760 will discharge C702. This results in a saw-tooth, having alternate charging and discharging phases.

The voltage saw-tooth node 751 charges capacitor C703 via diode 541, to produce the Vvalley-offset, at node 750 (that is, at the high side of capacitor C703). The valley-offset node 750 is also connected to ground via reset transistor 761, the gate of which is connected to the comparator output comp_out.

The current mirrors described above with reference to FIGS. 5 and 7 each comprise a pair of transistors, connected with common gate, and having the common gate connected to the drain of the input side transistor of the pair, and wherein the drain of the output side transistor provides a current which mirrors that through the input side transistor. However, alternative and equivalent forms of current mirror will be immediately apparent to the skilled person, and may be used to equal or similar advantage within the scope of the embodiment.

FIG. 6 show waveforms corresponding to the circuit diagram of FIG. 5. In particular, the figure shows the saw-tooth timing 601, the saw-tooth voltage 602 and the peak voltage offset 603. The saw-tooth timing 601 is the waveform of the signal input at the saw-tooth timing node 815 of FIG. 5; the saw-tooth voltage is the waveform of the Vsaw node 551 of FIG. 5, and the peak voltage offset corresponds to the waveform of the Vpeak_offest node 550 of FIG. 5. The loop delay duration is equivalent to the saw-tooth timing interval 611. Moreover, under the conditions shown, the peak voltage offset is constant, until a moment 613, when the comparator comprising the op-amp 511 and voltage follower 514 goes high.

From the above description, and since the two phases are implemented by different circuits, it will be apparent that the signal I2 of FIG. 1 and shown in FIG. 4, is not validly reproduced in this specific embodiment. In contrast, in this embodiment, the mirrored current exists only in one phase. I1 is still the current flowing in and out of C1, but each mirror is active in only one of these phase. During the opposite phase, the large resistance in parallel to C1 takes care of the current. That is to say, during the charging phase, R710 is operative, and during the discharge phase, R501 is operative.

The invention has been described with respect to a hysteretic converter embodiment; however, it is equally applicable to other forms of current control such as peak current control or valley current control.

Furthermore the invention has been described with reference to an embodiment which is implemented entirely by using analogue components. It would be immediately apparent to the skilled person that equivalent functionality can be achieved by digital signal processing, and such embodiments are included within this scope of the invention.

From reading the present disclosure, other variations and modifications will be apparent to the skilled person. Such variations and modifications may involve equivalent and other features which are already known in the art of DC-DC converters and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method of controlling a DC-DC converter having a first state and a second state each of which is either a charging state or a discharging state,
the DC-DC converter being arranged to change state from the first state to the second state in dependence on a predetermined limit value of a signal, and
having a delay between a change instruction and a change of state from the first state to the second state,
the method comprising the steps of:
(a) determining a rate signal indicative of the rate of change of the signal whilst the DC-DC converter is in the first state,
(b) determining a delay signal indicative of the delay,
(c) determining an overshoot in dependence on the rate signal and the delay signal, and
(d) offsetting the predetermined limit value by an amount which corresponds to the overshoot.

2. A method according to claim 1 wherein the first state is the charging state and the second state is the discharging state.

3. A method according to claim 2 wherein the signal is a voltage.

4. A method according to claim 3, wherein the overshoot is equal to the rate of change of voltage multiplied by the delay.

5. A method according to claim 4, wherein step (a) comprises applying a copy of the voltage across a first capacitor to produce a resulting current, and step (c) comprises charging a second capacitor with a mirror of the resulting current.

6. A method according to claim 5, wherein the overshoot is determined in step (c) by determining the voltage across the second capacitor, at the end of a charging period corresponding to the delay signal.

7. A method according to claim 1 wherein the first state is the discharging state and the second state is the charging state.

8. A method according to claim 7 wherein the signal is a voltage.

9. A method according to claim 8, wherein the overshoot is equal to the rate of change of voltage multiplied by the delay.

10. A method according to claim 9, wherein step (a) comprises applying a copy of the voltage across a first capacitor to produce a resulting current, and step (b) comprises charging a second capacitor with a mirror of the resulting current.

11. A method according to claim 10, wherein the overshoot is determined in step (c) by determining the voltage across the second capacitor, at the end of a charging period corresponding to the delay signal.

12. A method of controlling a DC-DC converter having a first state and a second state each of which is either a charging state or a discharging state,
the DC-DC converter being arranged to change state from the first state to the second state in dependence on a predetermined limit value of a signal, and
having a delay between a change instruction and a change of state from the first state to the second state,
the method comprising the steps of:
(a) determining a rate signal indicative of the rate of change of the signal whilst the DC-DC converter is in the first state,
(b) determining a delay signal indicative of the delay,
(c) determining an overshoot in dependence on the rate signal and the delay signal, and
(d) offsetting the predetermined limit value by an amount which corresponds to the overshoot; and
wherein the first state is the charging state and the second state is the discharging state;
and subsequently controlling the DC-DC converter according to steps (a) through (d);
wherein the first state is the discharging state and the second state is the charging state.

13. A method of controlling a DC-DC converter according to claim 1, wherein the DC-DC converter is operable either under hysteretic control or under peak current control and/or valley current control.

14. A controller for a DC-DC converter configured to control a DC-DC converter according to a method according to claim 1.

15. A DC-DC converter adapted to be controlled according to a method according to claim 1.
